(19) United States
(12) Patent Application Publication
(10) Pub. No.: US 2022/0266427 A1
(43) Pub. Date: Aug. 25, 2022

(54) POWER TOOL ATTACHMENT PART

(71) Applicant: ATLAS COPCO INDUSTRIAL TECHNIQUE AB, Stockholm (SE)

(72) Inventor: Johan RÖNBLOM, Saltsjö-Boo (SE)

(73) Assignee: ATLAS COPCO INDUSTRIAL TECHNIQUE AB, Stockholm (SE)

(21) Appl. No.: 17/627,063

(22) PCT Filed: Jul. 6, 2020
(86) PCT No.: PCT/EP2020/068942

§ 371 Date: Jan. 13, 2022

(30) Foreign Application Priority Data
Jul. 24, 2019 (SE) 1930253-8

(51) Int. Cl. B25B 23/147; B25B 21/00

(52) U.S. Cl. CPC B25B 23/147; B25B 21/002; B25B 17/02

(57) ABSTRACT

The present disclosure relates to a power tool attachment part for a power tool. The power tool attachment part comprises an elongate housing including an upper housing part and a lower housing part interconnected with the upper housing part, an input gear wheel for connection to an output shaft of a power wrench, which input gear wheel is arranged at a first end of the housing, an output gear wheel with an output connection, which output gear wheel is arranged at a second end of the housing, at least one intermediate gear wheel, which is arranged inside the housing to transmit the rotation of the input gear wheel to the output gear wheel, and at least one torque sensor configured to measure a deformation of the elongated housing.

### TECHNICAL FIELD

The invention relates to a power tool attachment part for a power tool.

### BACKGROUND

Power tool attachment part are generally used in confined spaces where it is not possible to use an ordinary power tool, due to that it is difficult to access the bolt or nut of the joint to be tightened. A power tool attachment part is also known as a crowfoot, a front part attachment or an offset attachment.

A power tool attachment part includes a plurality of gear wheels that transmit a rotating movement or torque from an input gear wheel to an output gear wheel. The gear wheels are generally located in a straight row, teeth against teeth, inside an elongate housing. In addition to the thickness of the housing wall the length of the attachment part corresponds to the sum of the width of the gear wheels. The power tool attachment part is generally used in confined spaces. Therefore, the size of the power tool attachment part is an important feature to keep as small as possible.

The torque in a power tool is typically measured by a transducer arranged inside the power tool. The internal measurement in the power tool may however not provide an accurate measurement of the torque that the power tool attachment part attached to the power tool is being subjected to.

EP3388199 discloses a screw device including a crowfoot connected to the screw device. The crowfoot is provided with helical gear wheels. The crowfoot includes a torque transducer configured to measure the torque of the helical gear wheel arranged adjacent to the output helical gear wheel. The torque measurement is based on the axial movement of the helical gear wheel and the transducer utilises a load cell to determine the torque.

The helical gear wheel structure is required to be able to perform the torque measurements. There are however crowfoots that utilise other gear wheel designs such as straight gear wheels. Also, torque transmitted over a number of gear wheels will further be affected by friction.

Hence, there is a need for an improved power tool attachment part that can solve or at least mitigate the above-mentioned problem.

### SUMMARY

An object is to provide a power tool attachment part with increased control of output torque compared to conventional power tool attachment parts.

According to an aspect there is presented a power tool attachment part for a power tool. The power tool attachment part comprises an elongate housing including an upper housing part and a lower housing part interconnected with the upper housing part, an input gear wheel for connection to an output shaft of a power wrench, which input gear wheel is arranged at a first end of the housing, an output gear wheel with an output connection, which output gear wheel is arranged at a second end of the housing, at least one intermediate gear wheel, which is arranged inside the housing to transmit the rotation of the input gear wheel to the output gear wheel, and at least one torque sensor configured to measure a deformation of the elongated housing.

By providing a torque sensor on the housing near the output gear wheel of the power tool attachment part, accuracy of the output torque is improved.

The at least one sensor may arranged on the lower housing part.

The at least one sensor may alternatively be arranged on the upper housing part.

The at least one sensor may be arranged on the elongated housing at one side of the one of the at least one intermediate gear wheels being adjacent the output gear wheel.

The power tool attachment part may further comprise an electronic box arranged on the elongated housing. The electronic box may be configured to receive measurements from the at least one torque sensor.

The electronic box may be connected to drive electronics of a power tool to which the power tool attachment part is configured to be connected to during use.

The electronic box may comprise a display, wherein the electronic box is configured to display a torque value measured by the at least one torque sensor.

The at least one sensor may be a strain gauge element.

The at least one sensor may alternatively be a piezo electric element.

Other features and advantages of the invention will be apparent from the figure and from the detailed description of the shown embodiments.

### BRIEF DESCRIPTION OF THE DRAWINGS

In the following detailed description reference is made to the accompanying drawings, of which:

FIG. 1 is a schematic diagram illustrating a power tool attachment part in explode view, wherein embodiments presented herein can be applied; and

FIG. 2 shows the power tool attachment part illustrated in FIG. 1 in a mounted state;

FIG. 3a is a schematic diagram illustrating a top view of a power tool attachment part according to an embodiment presented herein;

FIG. 3b is a schematic diagram illustrating an exploded view of a power tool attachment part according to an embodiment presented herein;

FIG. 4a is a schematic diagram illustrating a side view of power tool attachment part according to an embodiment presented herein;

FIG. 4b is a schematic diagram illustrating a top view of power tool attachment part according to an embodiment presented herein;

FIG. 5 is a schematic diagram illustrating some components of a torque sensor according to an embodiment presented herein; and

FIG. 6 is a schematic diagram illustrating some components of an electrical box according to an embodiment presented herein.

### DETAILED DESCRIPTION

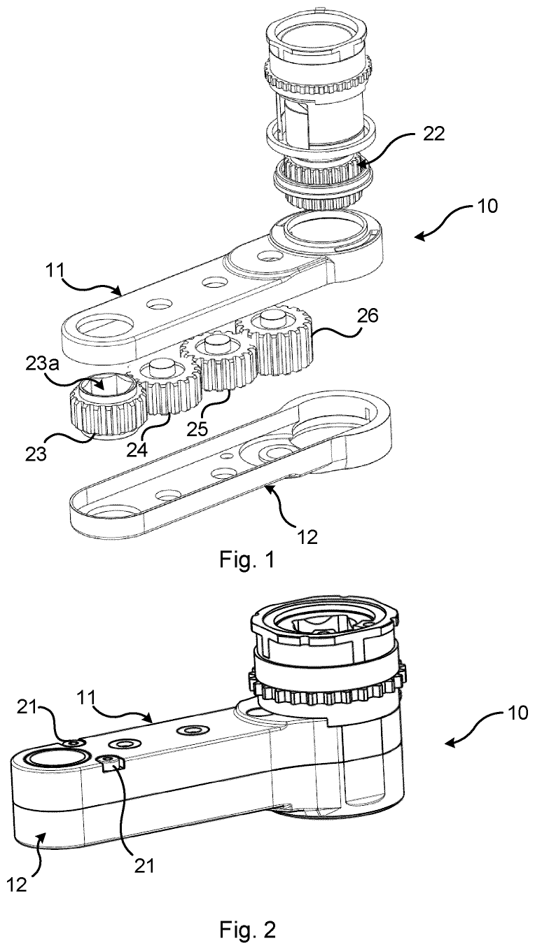

In FIG. 1 an example of a power tool attachment part 10 is shown, schematically illustrated an environment in which embodiments presented herein can be applied. The power tool attachment part 10 is a crowfoot comprises an elongate housing 11, 12 comprising an upper housing part 11 and a lower housing part 12. The upper housing part 11 is interconnected with the lower housing part 12. The power tool may for example be a wrench or a nut runner.

An attachment part for e.g. a power tool such as a power wrench is used in confined spaces where it may not be possible to use an ordinary power tool, due to that it is difficult or impossible to access the bolt or nut to be screwed. Hence, the size of the attachment part is an important feature. Small gear wheels are more sensitive to wear than larger gear wheels.

The exemplified power tool attachment part 10 has a construction that will decrease the wear and increase the durability compared to a conventional attachment part of the same accuracy and torque capacity. This will be apparent from the description below.

In FIG. 1, the power tool attachment part 10 is shown in an exploded view. The power tool attachment part 10 comprises an input gear wheel 22 and an output gear wheel 23 arranged in the elongate housing 11, 12. The input gear wheel 22 is arranged at a first end of the elongate housing 11, 12. The output gear wheel 23 is arranged at a second end of the housing 11, 12.

The input gear wheel 22 is drivingly connected to the output gear wheel 23 via one or more intermediate gear wheels. In the present example, there are three intermediate gear wheels 24, 25, 26, which are arranged to transmit the rotation of the input gear wheel 22 to the output gear wheel 23.

The output gear wheel 23 comprises an output connection 23a. The output connection 23a may e.g. be configured to receive a wrench bit, a screw bit, a nut or screw head.

The upper housing part 11 and the lower housing part 12 may each have a through-opening, which when the upper housing part 11 and the lower housing part 12 are assembled with each other are aligned. The through-openings are arranged in the first end of the elongate housing 11, 12. The through-openings are configured to receive the input gear wheel 22.

The gear wheels have been illustrated with straight teeth interfacing each other. The gear wheels may alternatively helical gear wheels.

In FIG. 2 the power tool attachment part 10 is schematically shown in mounted form. The power tool attachment part 10 is shown with the upper housing part 11 arranged on the lower housing part 12, such that the interior of the attachment part 10 is not visible. The upper housing part 11 may e.g. be fixed to the lower housing part 12 by fixing means 21.

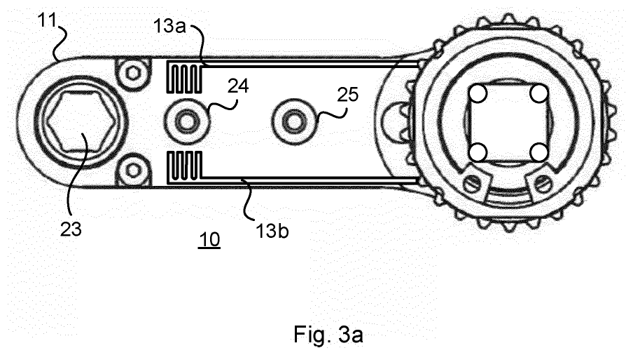

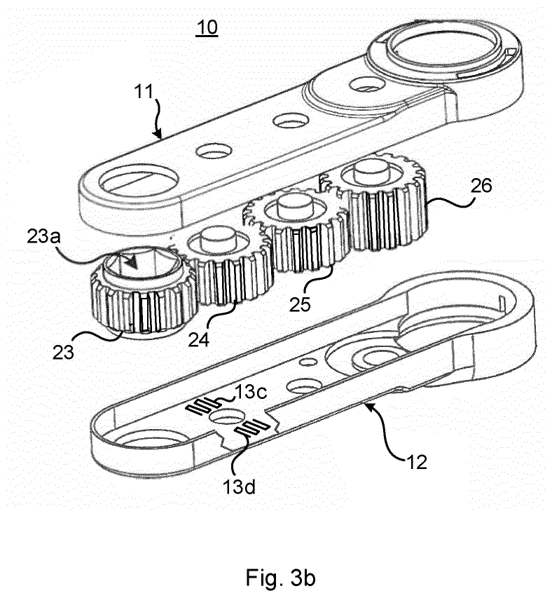

An embodiment of a power tool attachment part 10, as exemplified in connection with FIGS. 1 and 2, is presented with reference to FIG. 3a. The power tool attachment part 10 comprises two torque sensors 13a and 13b. The torque sensors 13a and 13b are arranged on the upper housing part 11 of the elongated housing 11, 12. The torque sensors 13a and 13b are positioned as close to the output gear wheel 23 as possible, in this case on opposite sides of the intermediate gear wheel 24. Each torque sensor 13a and 13b is configured to measure the torque and provide the measurement to a display for the user of the tool. When there is an output torque at the output gear wheel 23, the adjacent intermediate gear wheel 24 will be pushed straight sideways, which will influence the elongated housing 11, 12. The stress changes of the elongated housing 11, 12 is related to the moment thereof, and by adding at least one torque sensor 13 to the elongated housing 11, 12, the stress of the elongated housing 11, 12 can be measured providing a measure of the torque of the output gear wheel 23. One side of the elongated housing 11, 12 will contract, which will be detected by one torque sensor 13a and the other side of the elongated housing 11, 12 will extract, which will be detected by the other torque sensor 13b. The measurements may be signalled to a control device of a power tool to which the power tool attachment part 10 is connected to during use. The torque sensors 13a and 13b may be connected to the control device via wiring.

Another embodiment of a power tool attachment part 10, as exemplified in connection with FIGS. 1 and 2, is presented with reference to FIG. 3b. The power tool attachment part 10 comprises two torque sensors 13c and 13d. The torque sensors 13c and 13d are instead arranged on the lower housing part 12 of the elongated housing 11, 12. The torque sensors 13c and 13d are again positioned as close to the output gear wheel 23 as possible, in this case on opposite sides of the intermediate gear wheel 24. The torque sensors 13c and 13d may be connected to the control device via wiring (not illustrated).

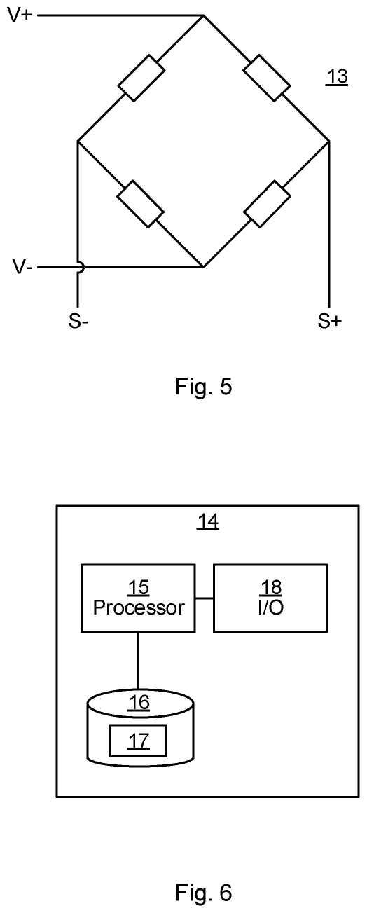

An example of a torque sensor configuration is illustrated in FIG. 5. The illustrated torque sensor 13 comprises four series-connected elements arranged in a Wheatstone bridge manner for difference measurements. A positive voltage V+ is added between two element and a corresponding negative voltage V− is added opposite the positive voltage between the other two elements. Sensing voltages S+ and S− are then read out from the other two positions of the bridge. The elements may e.g. be strain gauge elements. In an alternative example, the elements are piezo-electrical elements.

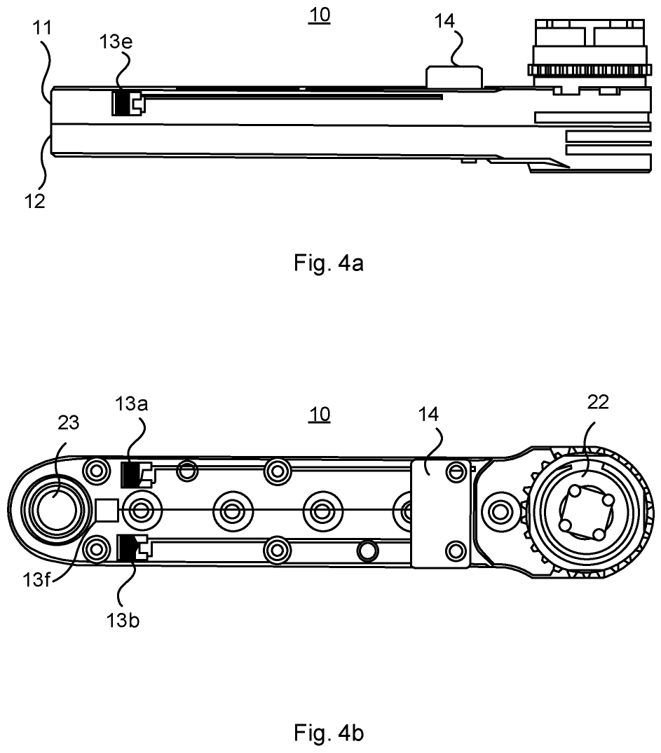

Yet an embodiment of a power tool attachment part 10 is presented with reference to FIGS. 4a and 4b. The power tool attachment part 10 comprises at least on torque sensor 13a, 13b, 13e or 13f. One torque sensor 13e may be arranged on the side of upper housing part 11 of the elongated housing 11, 12. One torque sensor 13a may be arranged on one side of an intermediate gear wheel adjacent the output gear wheel 23. One torque sensor 13b may be arranged on the other side of the intermediate gear wheel adjacent the output gear wheel 23. One torque sensor 13f may be arranged on the upper housing part 11 of the elongated housing 11, 12, between the output gear wheel 23 and the intermediate gear wheel adjacent the output gear wheel 23. Since it is desirable to keep the power tool attachment part 10 as small as possible, sufficient space for a torque sensor is dependent on the specific design of the power tool attachment part 10 as well as fixing means thereof. Wiring is illustrated straight in the drawings for simplicity, but is typically not arranged directly across fixing means or gear wheel bearings, but are instead arranged around obstacles.

The power tool attachment part 10 further comprises an electronic box 14 configured to receive measurements from one or more of torque sensors 13a-13f. The electronic box 14 is illustrated arranged close to the input gear wheel 22, but may alternatively be arranged in connection with one or more of the torque sensors 13a-13f.

The electronic box 14 may further comprise a display 18 configured to display received torque measurements. The electronic box 14 may also comprise a processing circuitry 15 and a computer program product 16 storing instructions 17 that, when executed by the processing circuitry 15, cause the electronic box 14 to receive measurement and or display of an output torque of a power tool connected to the power tool attachment part 10. The electronic box 14 may further or alternative be configured to send measurement to the control device of the power tool. The electronic box 14 may be connected to the control device via wire or wirelessly, directly to the control device or via the power tool. The electronic box 14 may be connected to drive electronics of a power tool to which the power tool attachment part 10 is connected to during use. Alternatively, the electronic box 14 may be provided with a battery for driving the electronic box 14.

Further, torque sensors have herein been illustrated to be on a surface of the elongated housing 11, 12. The torque sensors may alternatively be arranged depressed into the surface of the elongated housing, or integrally arranged inside the material of the elongated housing.

FIG. 6 is a schematic diagram showing some components of the electronic box 14. The processing circuitry 15 may be provided using any combination of one or more of a suitable central processing unit, CPU, multiprocessing circuitry, microcontroller, digital signal processing circuitry, DSP, application specific integrated circuit etc., capable of executing software instructions of a computer program x stored in a memory. The memory can thus be considered to be or form part of the computer program product 16.

The memory may be any combination of read and write memory, RAM, and read only memory, ROM. The memory may also comprise persistent storage, which, for example, can be any single one or combination of magnetic memory, optical memory, solid state memory or even remotely mounted memory.

The computer program product 16 may also be provided, e.g. for reading and/or storing data during execution of software instructions in the processing circuitry 15. The data memory can be any combination of read and write memory, RAM, and read only memory, ROM, and may also comprise persistent storage, which, for example, can be any single one or combination of magnetic memory, optical memory, solid state memory or even remotely mounted memory. The data memory may e.g. hold other software instructions 17, to improve functionality for the electronic box 14.

The electronic box 14 may further comprise an input/output (I/O) interface 18 including e.g. a user interface, particularly a display. The electronic box 14 may further comprise a receiver configured to receive signalling from other devices, and a transmitter configured to transmit wireless signalling to other devices (not illustrated). Other components of the electronic box 14 are omitted in order not to obscure the concepts presented herein.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

1. A power tool attachment part for a power tool, comprising:
an elongated housing including an upper housing part interconnected with the upper housing part;
an input gear wheel for connection to an output shaft of a power wrench, which input gear wheel is arranged at a first end of the housing;
an output gear wheel with an output connection, which output gear wheel is arranged at a second end of the housing;
at least one intermediate gear wheel, which is arranged inside the housing to transmit the rotation of the input gear wheel; and
at least one torque sensor arranged on the elongated housing, said at least one torque sensor being configured to measure a deformation of the elongated housing.

2. The power tool attachment part according to claim 1, wherein the at least one torque sensor is arranged as close as possible to the output gear wheel.

3. The power tool attachment part according to claim 1, wherein the at least one sensor is arranged on the lower housing part.

4. The power tool attachment part according to claim 1, wherein the at least one sensor is arranged on the upper housing part.

5. The power tool attachment part according to claim 1, wherein the at least one sensor is arranged on the elongated housing at one side of the one of the at least one intermediate gear wheels being adjacent the output gear wheel.

6. The power tool attachment part according to claim 1, further comprising:
an electronic box arranged on the elongated housing, the electronic box being configured to receive measurements from the at least one torque sensor.

7. The power tool attachment part as claimed in claim 6, wherein the electronic box is connectable to drive electronics of a power tool to which the power tool attachment part is configured to be connected to during use.

8. The power tool attachment part as claimed in claim 6, wherein the electronic box comprises a display, wherein the electronic box is configured to display a torque value measured by the at least one torque sensor.

9. The power tool attachment part according to claim 1, wherein the at least one sensor is a strain gauge element.

10. The power tool attachment part according to claim 1, wherein the at least one sensor is a piezo electric element.

11. The power tool attachment part according to claim 1, wherein the at least one torque sensor is arranged adjacent to the output gear wheel.
